(19) United States
(12) Patent Application Publication
(10) Pub. No.: US 2013/0201001 A1
(43) Pub. Date: Aug. 8, 2013

(54) END CONNECTION IDENTIFICATION DEVICE AND METHOD

(71) Applicant: Nitesh Ratnakar, Elkins, WV (US)

(72) Inventor: Nitesh Ratnakar, Elkins, WV (US)

(21) Appl. No.: 13/367,506

(22) Filed: Feb. 7, 2012

(51) Int. Cl. G08B 5/22

(52) U.S. Cl. 340/6.1

(57) ABSTRACT

An apparatus for identifying differing portions of an interconnecting device. The interconnecting device selectively interconnects a first component to a second component for delivery therethrough. The apparatus includes an interconnecting member including at least a first portion and a second portion, and a first identifying device positioned on the first portion. The first identifying device includes a first activation portion and a first identification portion. The apparatus also includes a second identifying device positioned on the second portion. The second identifying device includes a second activation portion and a second identification portion. An identifying signal transmitted by the first identification portion is identifiable with a signal emitted by the second identification portion.

### TECHNICAL FIELD

The disclosure relates generally to a method and apparatus for identifying the opposing ends of a connector, and specifically to identification of wire node ends.

### BACKGROUND

Connection points of components are often interconnected with multiple conduits. These conduits may contain wires, fiber optics, hollow channels for fluid transfer, or other suitable items.

Any conduit, such as a tube, hydraulic hose, duct, or a wire may be desirably connected from a specific connection point of a first component to a specific connection point of a second component. Often multiple components must be interconnected with multiple conduits. Conduits may be color coded to aid a user in ensuring a proper connection to the desired connection points. When multiple components are improperly interconnected, that is, when conduits are connected to an incorrect connection point, the system may not function properly and the user may not know what specific connection is incorrect.

What is needed is an apparatus and method for interconnecting connection points of multiple devices in a manner that reduces incorrect connections.

### SUMMARY

The interconnecting device selectively interconnects a first component to a second component for delivery therethrough. The apparatus includes an interconnecting member including at least a first portion and a second portion, and a first identifying device positioned on the first portion. The first identifying device includes a first activation portion and a first identification portion. The apparatus also includes a second identifying device positioned on the second portion. The second identifying device includes a second activation portion and a second identification portion. An identifying signal transmitted by the first identification portion is identifiable with a signal emitted by the second identification portion.

### BRIEF DESCRIPTION OF THE DRAWINGS

The drawings are illustrative embodiments. The drawings are not necessarily to scale and certain features may be removed, exaggerated, moved, or partially sectioned for clearer illustration. The embodiments illustrated herein are not intended to limit or restrict the claims.

FIG. 1 is schematic view of a connection between components, according to an embodiment.

FIG. 2 is an exploded sectional view of a connector, taken generally along line 2-2 of FIG. 1.

FIG. 3 is a partial view of the connector of FIG. 1.

FIG. 4 is a perspective view of a first end of the connector of FIG. 3, illustrated in a first configuration.

FIG. 5 is a perspective view of a second end of the connector of FIG. 3, illustrated in a second configuration.

FIG. 6 is an enlarged sectional view of the connector of FIG. 1, illustrated in a second configuration.

FIG. 7 is a perspective view of a first end of the connector of FIG. 6, illustrated in a first configuration.

FIG. 8 is a perspective view of a second end of the connector of FIG. 6, illustrated in a second configuration.

FIG. 9 is a schematic view of a connector, according to a third embodiment.

FIG. 10 is a perspective view of a first end of the connector of FIG. 9.

FIG. 11 is perspective view of a second end of the connector of FIG. 9, according to an embodiment.

FIG. 12 is an enlarged sectional view of a portion of area 12 of FIG. 19.

### DETAILED DESCRIPTION

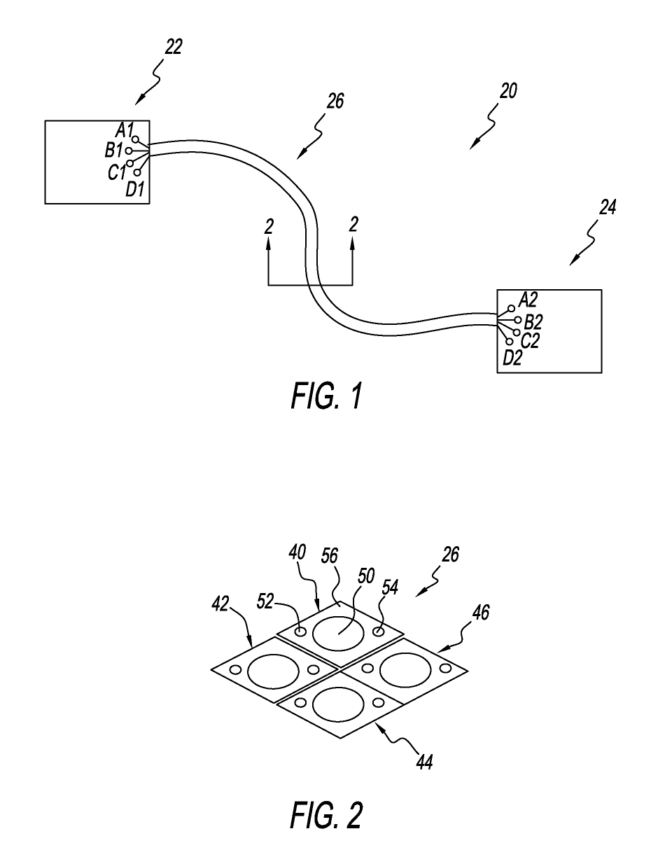

FIG. 1 illustrates an embodiment of an interconnected system 20. The system 20 includes a first component 22, a second component 24, and an interconnector 26. In the embodiment illustrated, the interconnector 26 includes a plurality of metallic electrical connectors 40, 42, 44 and 46, as discussed in greater detail below. As illustrated, the first component 22 includes connection points A1, B1, C1, and D1; and the second component 24 includes connection points A2, B2, C2, and D2.

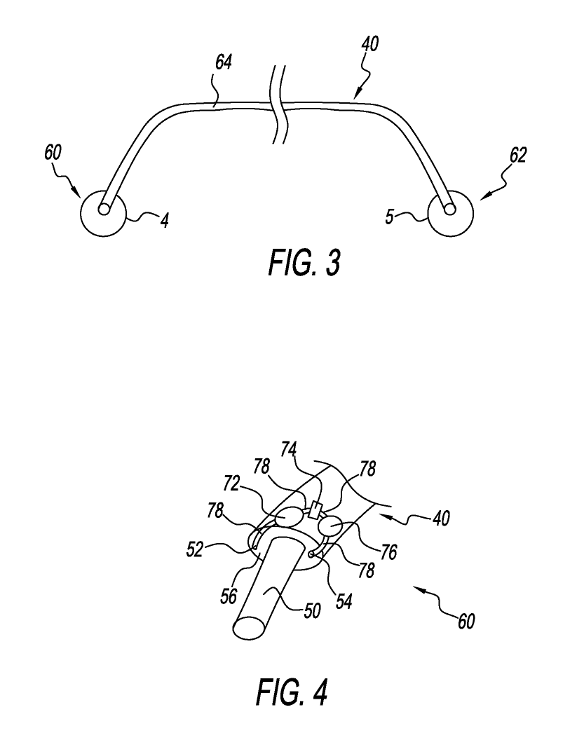

With reference to FIG. 2, in the embodiment illustrated, each connector 40, 42, 44, 46 includes an interconnecting portion 50, a first conductor 52, a second conductor 54, and a sheath 56. FIG. 3 illustrates the connector 40 to further include a first end 60 and a second end 62, and a central portion 64 interposed between the first end 60 and the second end 62.

FIG. 4 illustrates the first end 60 of the connector 40 to include an end portion of the interconnecting portion 50 extending therefrom, a first light emitting diode (LED) 72, a switch 74, a power source 76 and interconnecting members 78. In the embodiment illustrated, the first LED 72, the switch 74, and the power source 76 are electrically interconnected in series between the first conductor 52 and the second conductor 54 by the interconnecting members 78.

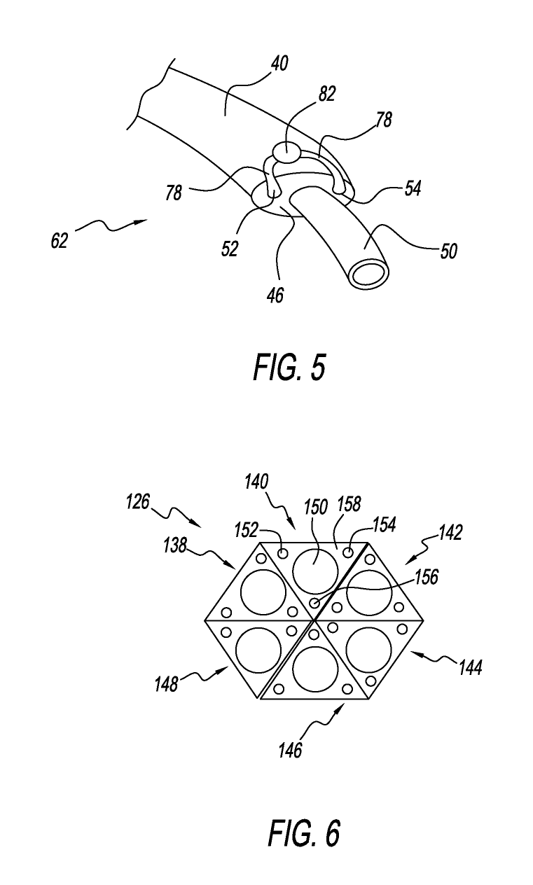

FIG. 5 illustrates the second end 62 of the connector 40 to include a plurality of interconnecting members 78 and a second LED 82. In the embodiment illustrated, the second LED 82 is electrically interconnected between the first conductor 52 and the second conductor 54 by the interconnecting members 78. Accordingly, the first LED 72, the switch 74, the power source 76, and the second LED 82 are electrically interconnected in a closed loop by the first conductor 52, the second conductor 54, and the interconnecting members 78.

In operation, when a user desires to interconnect the first component 22 and the second component 24, the user may interconnect the components by interconnecting connection point A1 with connection point A2, interconnecting connection point B1 with connection point B2, interconnecting connection point C1 with connection point C2, and interconnecting connection point D1 with connection point D2 using the interconnector 26.

The user may start by activating the switch 74 of the connector 40. When switch 74 is activated, both the first LED 72 of the connector 40 and the second LED 82 of the connector 40 are illuminated. The user may then connect the first end 60 of the interconnecting portion 50 of the connector 40 to the connection point A1. Further, the user may then connect the second end 62 of the interconnecting portion 50 of the connector 40 to the connection point A2. In this manner, the connection point A1 and the connection point A2 are interconnected. After the desired interconnection has been made, the user may then deactivate the switch 74 to cease illumination of the first LED 72 and the second LED 82 of the connector 40. The remainder of the connection points may be interconnected as desired using this method.

In the embodiment illustrated, the LEDs at both opposing ends of a single connector (such as the connector 40) emit the same color in order to aid the user in making a proper interconnection of the components 22, 24. Further, the LEDs of differing connectors (such as the connectors 40, 42, 44) emit a different color within a single interconnector (such as the interconnector 26) to aid the user in making a proper interconnection of the components 22, 24. When differing colors (and/or blinking rates) are used for differing connectors of the interconnector 26, more than one switch on a connector 40, 42, 44 may be activated such that more than one connector 40, 42, 44 has ends that are illuminated simultaneously.

In the embodiment illustrated, the connector 50 is a material that will transmit electricity although other suitable materials may be used, as desired. Further, the power source 76 may be adequate for only a single use or may be provided for multiple uses, such as when multiple disconnections and re-connections are contemplated.

FIGS. 6-8 illustrate another embodiment of the interconnector 26 as an interconnector 126. In the embodiment illustrated, the interconnector 126 includes a plurality of metallic electrical connectors 138, 140, 142, 144 146, and 148 that each include an interconnecting portion 150, a first conductor 152, a second conductor 154, a third conductor 156, and a sheath 158. The interconnector 126 also includes a first end 160 and a second end 162, and a central portion (not shown) interposed between the first end 160 and the second end 162.

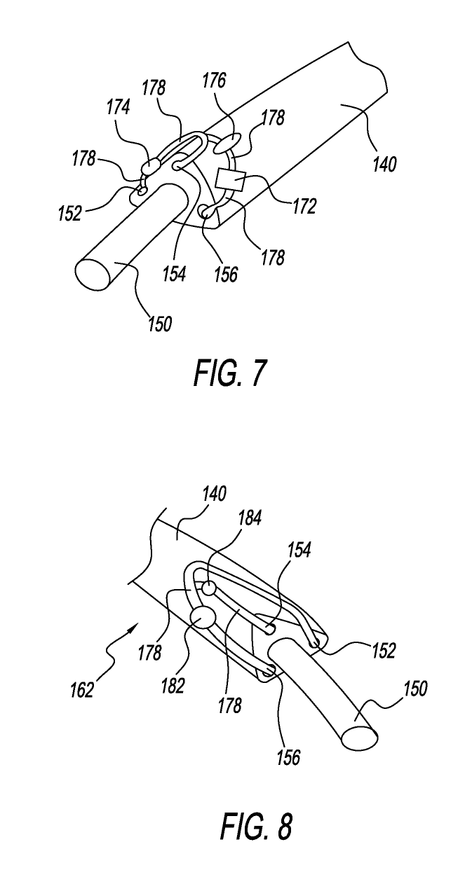

FIG. 7 illustrates the first end 160 of the connector 140 to include an end portion of the interconnecting portion 150 extending therefrom, a first light emitting diode (LED) 172, a first switch 174, a power source 176 and interconnecting members 178. In the embodiment illustrated, the first LED 172, the first switch 174, and the power source 176 are electrically interconnected in series between the first conductor 152 and the third conductor 156 by the interconnecting members 178. Also in the embodiment illustrated, the first LED 172, and the power source 176 are electrically interconnected in series between the second conductor 154 and the third conductor 156 by the interconnecting members 178.

FIG. 8 illustrates the second end 162 of the connector 140 to include a plurality of interconnecting members 178, a second LED 182, and a second switch 184. In the embodiment illustrated, the second LED 182 is electrically interconnected between the first conductor 152 and the third conductor 156 by the interconnecting members 178. Also in the embodiment illustrated, the second LED 182 and the second switch 184 are electrically interconnected between the second conductor 154 and the third conductor 156 by the interconnecting members 178.

Accordingly, the first LED 172, the first switch 174, the power source 176, and the second LED 182 are electrically interconnected in a closed loop by the first conductor 152, the third conductor 156 and the interconnecting members 178. Further, the first LED 172, the second switch 184, the power source 176, and the second LED 182 are electrically interconnected in a closed loop by the second conductor 154, the third conductor 156 and the interconnecting members 178. Therefore, by activating either the first switch 174 or the second switch 184 both the first LED 172 and the second LED 182 may be illuminated.

In operation, when a user desires to interconnect the first component 22 and the second component 24, the user may interconnect the components by interconnecting connection point A1 with connection point A2, interconnecting connection point B1 with connection point B2, interconnecting connection point C1 with connection point C2, and interconnecting connection point D1 with connection point D2 using the interconnector 26.

The user may start by activating either first switch 174 or the second switch 184 of the connector 140. When either switch is activated, both the first LED 172 of the connector 140 and the second LED 182 of the connector 140 are illuminated. The user may then connect the first end 160 of the interconnecting portion 150 of the connector 140 to the connection point A1. Further, the user may then connect the second end 162 of the interconnecting portion 150 of the connector 140 to the connection point A2. In this manner, the connection point A1 and the connection point A2 are interconnected. After the desired interconnection has been made, the user may then deactivate the switch to cease illumination of the first LED 172 and the second LED 182 of the connector 140. The remainder of the connection points may be interconnected as desired using a similar method.

FIGS. 9-12 illustrate an embodiment of the connector 40 as an interconnector 240. In the embodiment illustrated, the connector 240 includes an interconnecting portion 250, an optical fiber 252, a light splitter 254 and a sheath 258. The connector 240 also includes a first end 260, a second end 262, as third end 264, and a central portion 266 interposed between the ends.

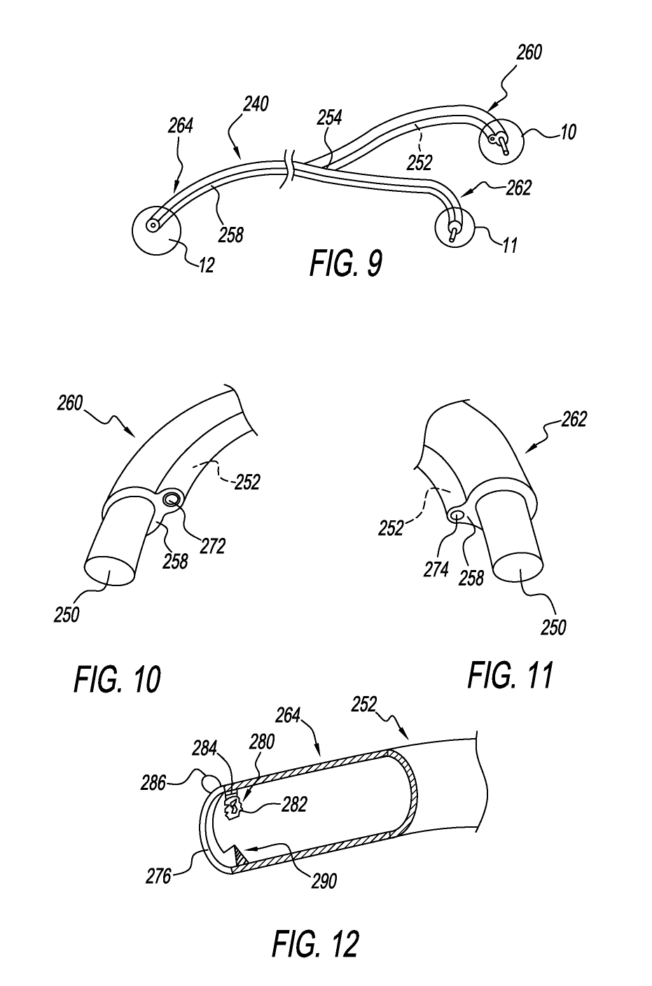

FIG. 10 illustrates the first end 260 of the connector 240 to include an end portion of the interconnecting portion 250 extending therefrom, a first end of the optical fiber 252, and a first LED lens 272. FIG. 11 illustrates the second end 262 of the connector 240 to include an end portion of the interconnecting portion 250 extending therefrom, a second end of the optical fiber 252, and a LED lens 274. FIG. 12 illustrates a portion of the third end 264 to include the optical fiber 254, a third LED lens 276, and a LED module 280. The LED module includes a LED 282, a power source 284, and a switch 286 for illuminating the LED. The switch 286 is positioned proximate the third LED lens 276 for convenience by the user when activating the switch 286. Further, the switch 286 may be activated by contacting the third LED lens 276. In the embodiment illustrated, the first LED lens 272, the second LED lens 274, and the third LED lens 276 are interconnected such that light transmitted through the optical fiber 252 and the light splitter 254 may be emitted from each of the first LED lens 272, the second LED lens 274, and the third LED lens 276.

In operation, a user may activate the switch 286 to illuminate the LED module 280. Therefore, by activating the LED module 280 both the first LED lens 272, the second LED lens 274, and the third LED lens 276 may be illuminated. Further, each of the ends 260, 262, 264 may include a LED module 280 for illuminating the LED lenses. Additionally, the connector 240 may include as many ends as desired with the light splitter 254 providing light to each LED lens.

In operation, when a user desires to interconnect the first component 22 and the second component 24, the user may interconnect the components by interconnecting connection point A1 with connection point A2, interconnecting connection point B1 with connection point B2, interconnecting connection point C1 with connection point C2, and interconnecting connection point D1 with connection point D2 using the interconnector 26.

The user may start by activating the switch 286 and thereby illuminating the first LED lens 272, the second LED lens 274, and the third LED lens 276. The user may then connect the first end 260 of the interconnecting portion 250 of the connector 240 to the connection point A1. Further, the user may then connect the second end 262 of the interconnecting portion 250 of the connector 240 to the connection point A2; and the third end 264 of the connector 240 to a desired connection point. In this manner, the desired connection points are interconnected. After the desired interconnection has been made, the user may then deactivate the switch 286 to cease illumination of the LED lenses of the connector 240. The remainder of the connection points may be interconnected as desired using a similar method.

In a further embodiment, the LEDs may replaced by vibration emitters to produce a vibration at opposing ends of a connector, thereby aiding a user when interconnecting devices.

Although the steps of the method of assembling the system 20 may be listed in an order, the steps may be performed in differing orders or combined such that one operation may perform multiple steps. Furthermore, a step or steps may be initiated before another step or steps are completed, or a step or steps may be initiated and completed after initiation and before completion of (during the performance of) other steps.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. An apparatus for identifying differing portions of an interconnecting device, the interconnecting device selectively interconnecting a first component to a second component for delivery therethrough, the apparatus comprising:
an interconnecting member including at least a first end portion and a second end portion;
a first identifying device positioned on the first end portion, wherein the first identifying device includes a first activation portion and a first identification portion;
a second identifying device positioned on the second end portion, wherein the second identifying device includes a second identification portion;
wherein an identifying signal transmitted by the first identification portion is selectively emitted simultaneously with a signal emitted by the second identification portion upon activation of the first activation portion.

2. The apparatus of claim 1, further comprising a closed loop circuit.

3. The apparatus of claim 1, wherein the first identifying device is a LED.

4. The apparatus of claim 1, wherein the first identifying device selectively emits a vibrational signal.

5. The apparatus of claim 4, wherein first identifying device is interconnected to the second identifying device by an optical fiber.

6. The apparatus of claim 1, wherein the second identifying device includes a second activation portion.

7. The apparatus of claim 1, further comprising: a third end portion of the interconnecting member, and a third identifying device positioned on the third end portion, wherein the third identifying device includes a third identification portion.

8. The apparatus of claim 7, wherein the first identifying device, the second identifying device, and the third identifying device are interconnected with an optical fiber.

9. The apparatus of claim 1, wherein the interconnecting device transports a fluid from the first component to the second component.

10. The apparatus of claim 1, wherein the interconnecting device is an electrical cable.

11. A method of identifying at least two portions of an interconnecting member, comprising:
activating a first identifying mechanism adjacent a first end of the interconnecting member;
emitting a first identifying signal by the first identifying mechanism;
emitting a second identifying signal by a second identifying mechanism positioned adjacent a second end of the interconnecting member, wherein the first identifying signal is identifiable with the second identifying signal, thereby enabling the identification of differing ends of the interconnecting member;
activating a first identifying device adjacent a first portion of a second interconnecting member;
emitting a first device identifying signal by the first identifying device; and
emitting a second device identifying signal by a second identifying device positioned at a second portion of the second interconnecting member, wherein the first device identifying signal is identifiable with the second device identifying signal, thereby enabling the identification of differing portions of the second interconnecting member,
wherein the first device identifying signal is not identical to either the first identifying signal or the second identifying signal, and the second device identifying signal is not identical to either the first identifying signal or the second identifying signal.

12. The method of claim 11, further comprising: coupling the first identifying mechanism with the second identifying mechanism such that activation of the first identifying mechanism initiates the activation of the second identifying mechanism.

13. The method of claim 11, further comprising: coupling the first identifying device with the second identifying device such that activation of the first identifying device initiates the activation of the second identifying device.
